(19) United States
(12) Patent Application Publication
(10) Pub. No.: US 2005/0198257 A1
(43) Pub. Date: Sep. 8, 2005

(54) Power conservation in wireless devices

(76) Inventors: Ajay G. Gupta, Temecula, CA (US); Ranjit S. Narjala, Hillsboro, OR (US); Michael B. Andrews, Beaverton, OR (US); Jon W. Inouye, Portland, OR (US); Victor B. Lortz, Beaverton, OR (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/749,803

(22) Filed: Dec. 29, 2003

(51) Int. Cl. G06F 15/173

(52) U.S. Cl. 709/224

(57) ABSTRACT

Structures and methods for conserving power in wireless, multi-homed communication devices includes powering down unused network communication devices while leaving an active or most desired network communication device active. A prioritized list of the available network communication devices, based on user preferences, is used to activate the desired network communication device(s) and power down the other network communication devices.

### FIELD

This invention relates to methods and structures for power conservation in wireless devices.

### BACKGROUND

Wireless electronic devices that communicate with wireless networks are becoming increasing popular to avoid the limitations and costs associated with wired, mechanically connected, networks. Wireless devices have network interface cards that are continuously powered and connect to the wireless network. However, different wireless standards/technologies require a specific network interface card that supports the wireless standard/technology of the wireless network in which the wireless electronic device is located. With the freedom of wireless devices, it is desired that the devices be mobile and portable. Of course mobile devices must have a power supply, typically, a battery. A battery has a limited supply of electrical energy and must be replaced or recharged as the battery runs out of stored energy. Accordingly, there is a limit to how long a wireless electronic device running on a battery can be used before it must be replaced or recharged. Users of wireless electronic devices at times find it inconvenient to stop using the wireless device to replace or recharge the battery. Moreover, the use of disposable batteries can be prohibitive due to cost and environmental concerns. The use of rechargeable batteries in some wireless devices require specially adapted plug-ins or transformers to recharge the battery. The users of such device must carry the plug-in or the transformer to recharge the battery. As a result, there is a need to conserve power in wireless devices to lengthen use time between replacing or recharging the battery.

### BRIEF DESCRIPTION OF THE DRAWINGS

FIG. 1 is a block diagram of a wireless network system in accordance with an embodiment of the invention.

FIG. 2 is a block diagram of a wireless device in accordance with an embodiment of the invention.

FIG. 3 is a block diagram of a wireless device in accordance with an embodiment of the invention.

FIG. 4 is a block diagram of a wireless device in accordance with an embodiment of the invention.

FIG. 5 is a flow chart in accordance with an embodiment of the invention.

### DESCRIPTION

In the following description of some embodiments of the present invention, reference is made to the accompanying drawings which form a part hereof, and in which are shown, by way of illustration, specific embodiments of the present invention which may be practiced. In the drawings, like numerals describe substantially similar components throughout the several views. These embodiments are described in sufficient detail to enable those skilled in the art to practice the embodiments of the present invention. Other embodiments of the invention may be utilized and structural, logical, and electrical changes may be made without departing from the scope. The following detailed description is not to be taken in a limiting sense, and the scope of the claimed embodiments of the present invention is defined only by the appended claims, along with the full scope of equivalents to which such claims are entitled.

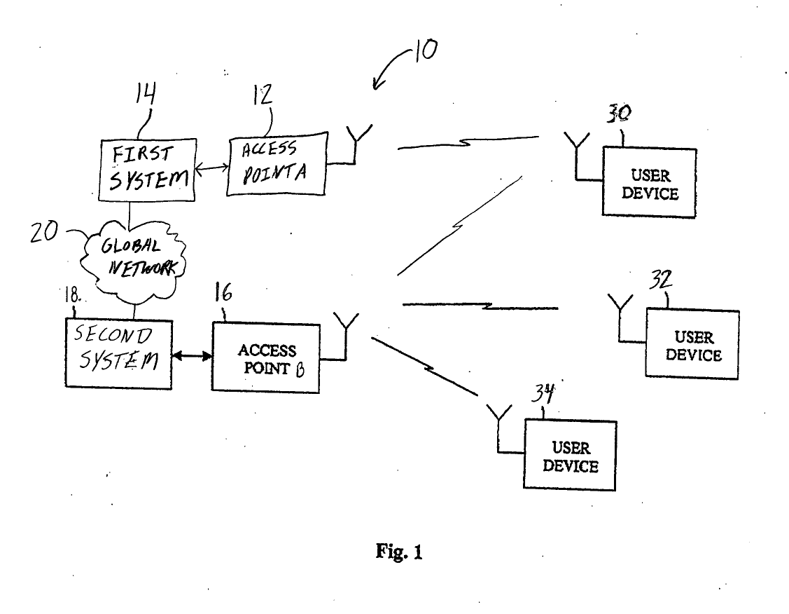

FIG. 1 is a block diagram of wireless network system 10 according to an embodiment of the invention. This system is an example and other systems may be used with various embodiments of the present invention. A first wireless base-station 12 provides access and electrical communication to a first electronic system 14 by at least one wireless user device 30, 32, and 34. An example of the first electronic system 14 is a wireless local area network (LAN). It will be recognized that other wireless technologies can be used. In an embodiment, the base-station 12 is adapted to connect a plurality of user devices to the electronic system 14. A second wireless base-station 16 provides access to a second electronic system 18. An example of the second electronic system 18 is a wireless local area network (LAN). It will be recognized that other wireless technologies can be used. In an embodiment, at least one of the base-stations 12 and 16 is an access point. The second wireless base-station 16 is, like base-station 12, adapted to connect at least one and, in an embodiment, a plurality of user devices 30, 32, and 34 to electronic system 18. As is becoming more common in today's networking environment, there are multiple wireless signals, e.g., emitting from both base-stations 12 and 16, available in the given area of system 10. The size of the given area depends on the signal strength and propagation properties of the particular wireless networking standards/technologies. The electronic systems 14 and 18 are each connected to a global computer network 20 (wide area network, internet, etc.) in an embodiment. It will be recognized that the electronic systems 14 and 18 may be stand alone networks that are not connected to a global computer network. Each electronic system 14 and 18 may include a plurality of wired or wireless access points for connection to additional devices. In an embodiment, electronic systems 14 or 18 typically include one or more servers that manage network resources. The servers may include file servers, print servers, network servers, email servers, and database servers. In embodiments of the present invention, the user devices 30, 32, 34 include at least one wired connection to an electronic system, such as one of system 14 or 18. Examples of wired connections include modems, e.g., 28k, 56k, etc., DSL, ISDN, T1 and other connections.

The user devices 30, 32, 34 include, in various embodiments of the invention, any of a wide variety of different digital data handling devices including, for example, laptop, palmtop, and/or desktop computers; personal digital assistants (PDA); pagers; and/or other electronic communication equipment. The number of user devices that can be supported by a single base-station 12 or 16 varies from system to system.

The user devices 30, 32, 34 each include wireless transceiver functionality that is capable of establishing and maintaining a wireless communication link with a corresponding base-station 12 or 16. The wireless transceiver functionality will often comply with one or more wireless networking standards or technologies. Some common wireless networking standards/technologies include, for example: Institute of Electrical and Electronics Engineers (IEEE) 802.11 standards such as IEEE 802.11a, b, g, . . . , n; IEEE 802.15; IEEE 802.2; and Bluetooth specification. For more information regarding some of the wireless networking standards/technologies mentioned above, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and “Bluetooth System Specification, Bluetooth Special Interest Group, Ver. 1.1, March 2001”, and related amendments. Other standards/technologies include HomeRF™ (please refer to “HomeRF Specification Home RF”, Jul. 1, 2002); HiperLAN (please refer to “Doc. No. EN 301 811-1-1 Ver. 1.1.1”, Jan. 1, 2001, European Telecommunications Standards Institute); Ultrawideband; wireless asynchronous transfer mode (WATM); digital enhanced cordless telecommunications (DECT); Wireless Universal Serial Bus (USB); Wireless IEEE 1394; Wireless Local Area Network (WLAN), General Packet Radio Service (“GPRS”, please refer to Doc. No. EN 301 113 V6.1.1 (1998-11), European Telecommunications Standards Institute) and others. A further standard/technology is wireless personal area network (PAN). A wireless PAN is a short-distance wireless network specifically designed to support portable and mobile computing devices such as PCs, PDAs, wireless printers and storage devices, cell phones, pagers, set-top boxes, and a variety of consumer electronics equipment in an ad hoc network. Bluetooth is an example of a wireless PAN. A further standard/technology is IEEE 802.16 wireless metropolitan area network (WMAN), see IEEE Std. 802.16-2001 IEEE Standard for Local and Metropolitan area networks Part 16: Air Interface for Fixed Broadband Wireless Access Systems. A further standard/technology is a wireless wide area network (WWAN). It will also be appreciated that wireless technologies that have been principally adopted in mobile telephone devices, such as CDMA, 3G and eventually 4G cellular standards are used in embodiments of the present invention. All publications listed herein are incorporated by reference for any purpose. Accordingly, the embodiments of the present invention are adaptable to a variety of wireless standards/technologies.

One or more of the user devices 30, 32, 34 include, in an embodiment, a wireless network interface card (NIC) (e.g., an 802.11b NIC, etc.) that is installed within an appropriate input/output port of the device. Similarly, one or more of the user devices 30, 32, 34 include, in an embodiment, wireless network components that are directly integrated within the device, i.e., without using an add-on card or board. An antenna, other radiating device, or transducer will also typically be provided within user device 30, 32, 34. In one implementation, radio frequency (RF) energy is used to provide wireless communication between each user device and a corresponding access point. It should be appreciated, however, that other forms of wireless signaling (e.g., infrared signaling, etc.) may alternatively be used.

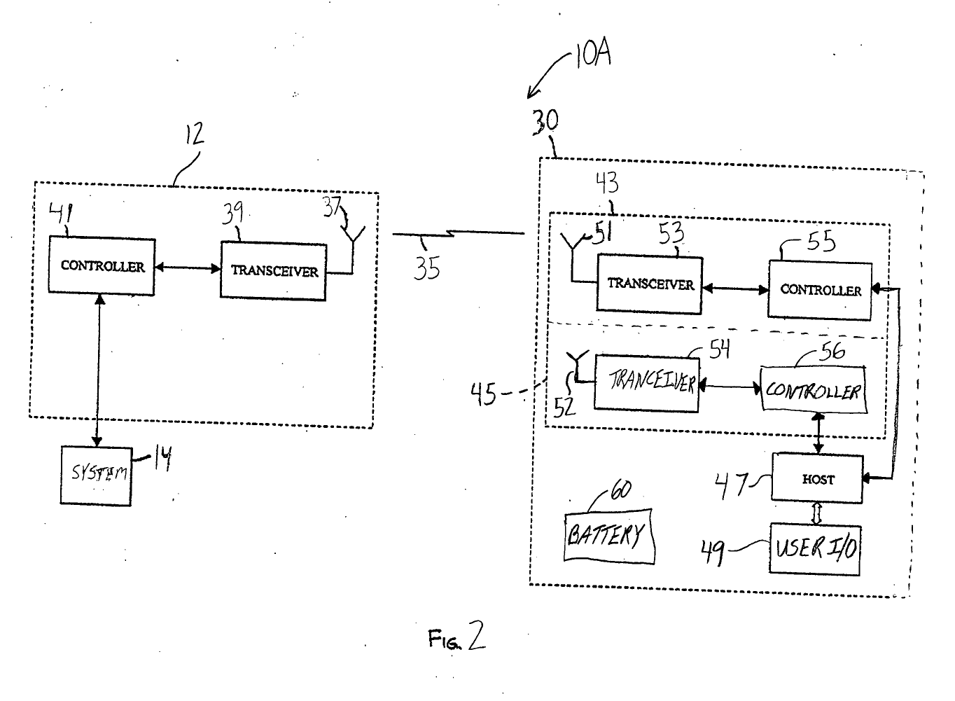

FIG. 2 is a block diagram illustrating a wireless arrangement 10A according to an embodiment of the present invention. As illustrated, the wireless arrangement 10A includes a wireless base-station 12, at least one user device 30, and a wired electronic system 14. The wireless base-station 12 provides access to the wired electronic system 14 for the user device 30. The user device 30 communicates with the wireless base-station 12 via a wireless communication channel 35. The wireless access point 12 includes an antenna 37, a transceiver 39, and a controller 41. The user device 30 includes a first wireless network interface card (NIC) 43, a second wireless network interface card (NIC) 45, a host 47, and a user interface 49. The host 47 includes a digital signal processing device such as a microprocessor, application specific integrated circuit or programmable logic array. Host 47 includes wired network connections in an embodiment.

Wireless NICs 43 and 45 include an antenna 51 and 52, a transceiver 53 and 54 and a controller 55 and 56. Wireless NICs 43 and 45 are, in an embodiment, removably coupled to the host 47 at an input/output (I/O) port thereof. Examples of I/O ports include, but are not limited to an expansion slot or PCMCIA slot. Alternatively, the functionality of the wireless NICs 43, 45 are made an integral part of the user device 30. That is, the NIC functions are implemented within the hardware and encoded software within device 30 and not as an add-on card or board. The first NIC 43 operates accordingly to a first wireless networking standard/technology. The second NIC 45 operates accordingly to a second wireless networking standard/technology different than the first wireless networking standard/technology. For example, the first NIC operates according to an IEEE 802.X standard (such as IEEE 802.11a, b, g, . . . , 802.2, etc.) and the second NIC operates according to General Packet Radio Service (GPRS) standard. The user device 30 supporting a plurality of different wireless networking standards/technologies results in a multi-homed device that can communicate with a LAN or other network through a variety of different standards/technologies. User device 30 further includes a power source, and in the embodiment of the user device 30 being mobile the power source is a battery 60. The battery 60 is in electrical communication with NICs 43 and 45, host 47, and user I/O 49 to provide electrical power thereto. It should be appreciated that the individual blocks illustrated in FIG. 2 are functional in nature and do not necessarily represent discrete hardware elements. For example, in at least one embodiment, two or more of the functional blocks (or portions thereof) are implemented in software within a common digital processing device (e.g., a general purpose microprocessor, a digital signal processor (DSP), a reduced instruction set computer (RISC), a complex instruction set computer (CISC), a field programmable gate array (FPGA), an application specific integrated circuit (ASIC), or others). Individual functions may also be divided among multiple digital processing devices.

The transceiver 51 within the NIC 43 is operative for performing conventional radio frequency (RF) receiver and transmitter functions for the user device 30. That is, during a transmit operation, the transceiver 53 will convert baseband information from the controller 55 into a RF transmit signal for delivery into the wireless channel 35 via antenna 51. During a receive operation, the transceiver 53 will process a RF signal received from the wireless channel 35 by antenna 51 to extract baseband information therefrom. Although illustrated as a single unit, the transceiver 53 may be implemented as separate transmitter and receiver units. Appropriate duplexer functionality may also be provided to allow the transmit and receive functions to share a common antenna 51. In an alternative approach, separate transmit and receive antennas are provided within the wireless NIC 43. The transceiver 39 within the wireless base-station 12 is similar in function to the transceiver 53 of the wireless NIC 43 described above. In at least one implementation, the transceiver 39 includes multiple independent transmit/receive channels to support simultaneous wireless communication with multiple remote user devices. The transceiver 39 while being able to communicate with multiple remote user devices typically uses only a single wireless networking standard/technology and accordingly communicates with wireless NIC 43.

Wireless NICs 43 and 45 each in operation continuously scan for a signal from a wireless base-station 12 and 16, such as access points. This continuous scanning and transmission of signals required to locate and stay connected to an electronic system, such as a wired LAN and a wireless LAN, through a base-station consumes a large amount of power. This is a problem for battery powered user device 30. It is desirable to have a plurality of different wireless NICs in a user device so that the user may connect to a plurality of different networks through a plurality of different wireless networking standards/technologies, thus increasing the likelihood that a user can find a wireless location (sometimes referred to as a “hot spot”) to use wireless device 30. However, continuously powering a plurality of continuously scanning and transmitting wireless NICs 43 and 45 further increases power consumption and undesirably drains the battery 60. The user device 30 includes a system and a method for selectively powering down or turning off unused NICs to preserve power while maintaining connectivity between user device 30 and the base-station 12. This will prolong the life of battery 60 while providing desired wireless connectivity between the user device 30 and base-station 12 and electronic system 14.

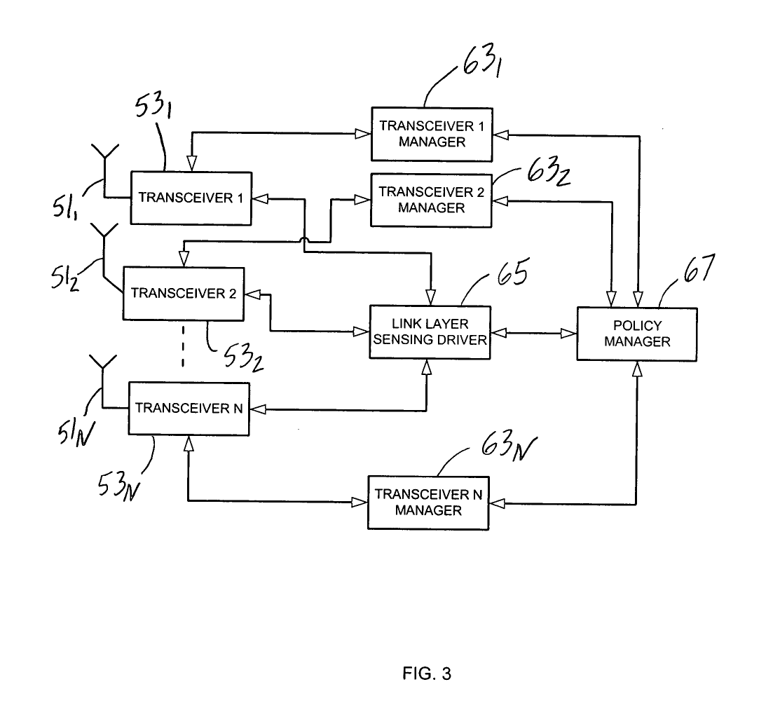

FIG. 3 is a block diagram of the wireless connectivity portion of wireless device 30 according to an embodiment of the invention. Wireless device 30 includes a plurality of antennas 51₁, 51₂, . . . 51_{N} respectively connected to a plurality of transceivers 53₁, 53₂, . . . 53_{N}. The plurality of transceivers 53₁, 53₂, . . . 53_{N} are respectively connected to and controlled by a plurality of transceiver managers 63₁, 63₂, . . . 63_{N}. Each set of transceiver manager, transceiver and antenna (e.g., 51₁, 53₁, and 63₁, or 51_{N}, 53_{N}, and 63_{N},) form wireless network adapters that enable wireless device 30 to communicate with a wireless network using a plurality of different wireless networking standards/technologies, i.e., device 30 is a multi-homed wireless device. The transceiver managers 63₁, 63₂, . . . 63_{N} manage network connectivity and configuration parameters for the transceivers of a respective type. A link-layer sensing driver 65 is connected to all of the transceivers 53₁, 53₂, . . . 53_{N} and detects the presence and types of network adapters in the user device 30. In an embodiment, the link-layer sensing driver 65 is a kernel level software component in the software running the user device 30. Sensing driver 65 monitors the networking state of all transceivers 53₁, 53₂, . . . 53_{N}. A policy manager 67 connects to the link-layer sensing driver 65 and the transceiver managers 63₁, 63₂, . . . 63_{N}. The policy manager 67 is a higher level software component, e.g., an application level component, than the link-layer sensing driver 65. The policy manager 67 programs and stores policy settings based on user preferences. The policy manager 67 implements the policy settings based on network adapter state information received from the sensing driver 65. In an embodiment, the policy manager 67 includes a listing of preferred network adapters. As used herein the term “preferred” refers to a relative position of a network device in a hierarchical listing of such devices. That is, a most preferred network device is the first in a list of such devices. For example, in some embodiments of the invention the use of the network adapter such as NIC 43 (FIG. 2) or transceiver 53₁ (FIG. 3) is the most preferred. The sensing driver 65 senses that the preferred network adapter, for example, NIC 43 (FIG. 2) or transceiver 53₁ (FIG. 3) is operational and is in the presence of wireless signal that corresponds to the wireless standard of the preferred network adapter. The policy manager 67 receives this data from the sensing driver 65. The policy manager 67 then allows the transceiver manager 63₁ of the preferred network adapter to run the transceiver 53₁ and establish communication with a base-station, that is, remain active. An active wireless network adapter is fully powered and is operational to scan for a wireless network. The transceiver manager 63₁ now performs specific actions based on the network requirements for a particular network standard/technology. For example, the transceiver manager launches a particular virtual private network (VPN) client to complete connection to the network through a base-station 12 or 16. In an embodiment, the policy manager 67 labels the remaining network adapters, e.g., NIC 45 (FIG. 2) and transceivers 53₂ and 53_{N}, as currently non-preferred adapters. Policy manager 67 further instructs the remaining wireless network adapters to deactivate, that is, power down, either in a very low power standby mode or turn completely off. In an embodiment, the policy manager 67 instructs the transceivers 53₂ and 53_{N} through the transceiver managers 63₂ and 63_{N}, respectively, to stop transmitting radio signals. As a result, a connection is established between the user device 30 and base-station/wired LAN and battery life in the user device is conserved. In an embodiment, the policy manager 67 deactivates or powers down wired network adapters in a similar manner as down with wireless network adapters and includes the wired network adapters with all activation, deactivation, and prioritization as described herein with respect to wireless network adapters. The policy manager 67 further prioritizes the activation of wireless network adapters when connection to a wireless base-station and an electronic system, e.g., a wired LAN, is needed. If the user desires device 30 to connect to a base-station 12 or 16 and the driver 65 senses that no wireless network adapter is active, then the policy manager 67 activates the preferred wireless network adapter. For example, the preferred wireless network adapters are NIC 43 (FIG. 2) or transceiver 53₁ (FIG. 3). Activation includes instructing the wireless network adapter to power on and attempt to connect to a wireless network. The policy manager monitors whether the preferred network wireless adapter connects to a wireless network, e.g., through a wireless base-station. If a connection is not established as sensed by the sensing driver 65, the policy manager 67 activates the next wireless network adapter in a hierarchy stored in the policy manager. In an embodiment, the policy manager 67 activates NIC 45 (FIG. 2) or transceiver 53₂ (FIG. 3). Policy manager 67 then instructs the preferred wireless network adapters to shut down or operate in a reduced power mode. This process repeats itself until a connection is established or there are no further wireless network adapters in the hierarchy. At such a time, the policy manager 67 informs the user through user I/O that a connection can not be established. In an embodiment, the policy manager 67 restarts at the top of the hierarchy of wireless network adapters to attempt to establish a connection. In an embodiment, the policy manager 67 includes wired network adapters in the hierarchy.

The embodiments of the present invention described herein provide methods and systems to conserve power in multi-homed user devices 30, 32, or 34. The policy manager 67 selects the best connection between a network adapter and a base-station 12, 16 as specified by the user. In an embodiment the policy manager 67 selects the best wireless network adapter 43 or 45; 53₁, 53₂, 53₃ and a base-station 12, 16 as specified by the user. The sensing driver 65 continuously senses the state of the network adapters. If an adapter's connection is dropped or if a more preferred adapter becomes available, then the sensing driver 65 informs the policy manager 67. The policy manager 67 can then activate the next preferred network adapter if the most preferred connection is dropped. The policy manager 67 can also activate the more preferred network adapter if the more network adapter becomes available.

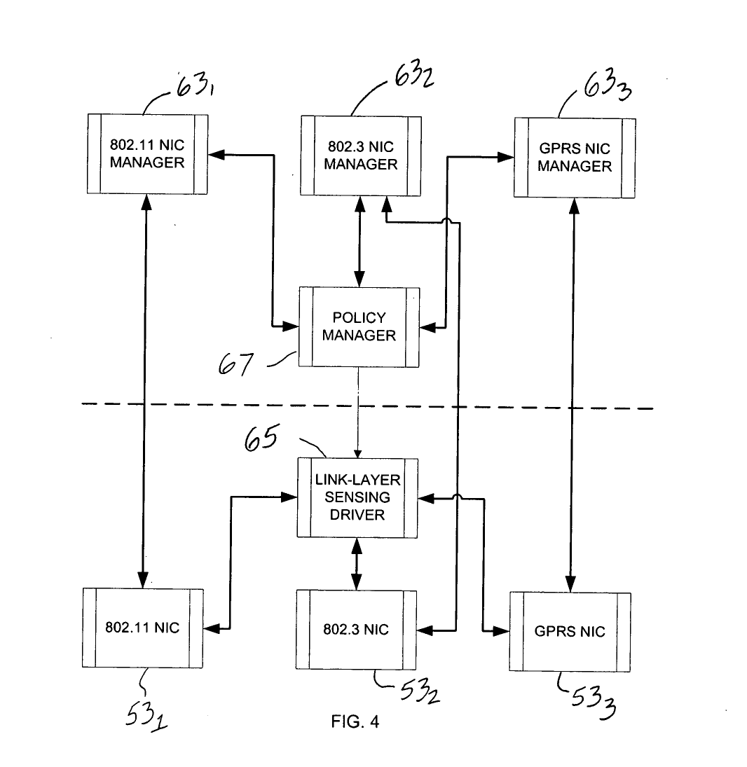

FIG. 4 is a block diagram of a wireless device 30 according to an embodiment of the invention. FIG. 4 is similar to FIG. 3 but shows specific wireless networking standards/technologies. Wireless device 30 includes three NIC 53₁, 53₂, and 53₃ respectively for use with the IEEE 802.11 standard, the IEEE 802.3 standard, and the GPRS standard. Wireless device 30 includes three NIC managers 63₁, 63₂, and 63₃ respectively for use with NIC 53₁ and the IEEE 802.11 standard, NIC 53₂ and the IEEE 802.3 standard, and NIC 53₃ and the GPRS standard. The policy manager 67 and the NIC managers 63₁, 63₂, and 63₃ are high level software components in an embodiment. The sensing driver 65 is a kernel level software component in an embodiment. Accordingly, the sensing driver 65 and the policy manager 67 are at different levels or rings in the architecture of the user device 30.

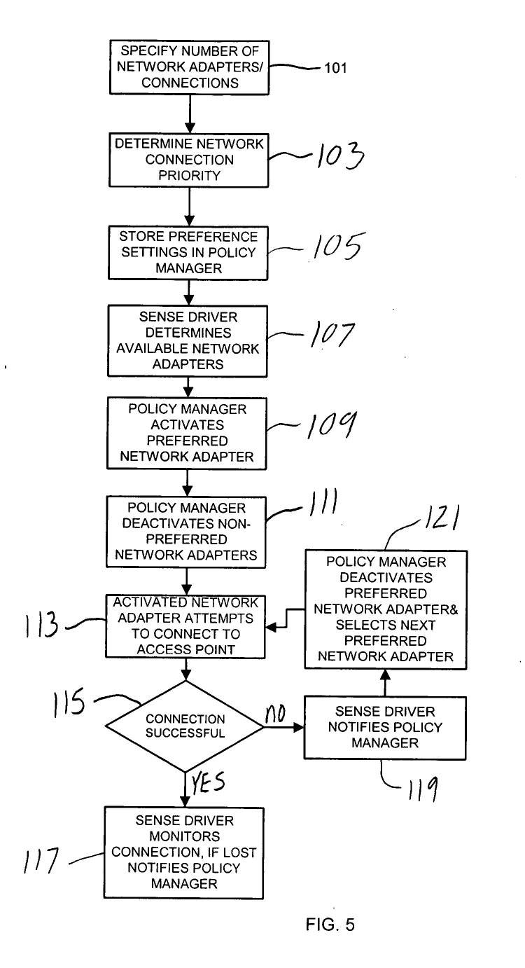

FIG. 5 shows a flow chart according to an embodiment of the invention. The policy manager 67 stores networking preference settings, which are based on user preferences. The networking preference settings are programmed by the user, either manually or by installation of network adapters, e.g., NICs 43, 45, 53₁, 53₂, and 53₃. A number of network adapters and/or connections are specified, 101, for a user device 30. A prioritized list or hierarchy of network adapters and/or connections are determined, 103. The hierarchy is determined, in an embodiment, by the frequency of use of a particular wireless network. For example, if the user device 30 typically connects to an IEEE 802.11g network, then the network adapter associated with the IEEE 802.11g standard, e.g., adapter 53₁ of FIG. 4, is selected as the preferred network adapter. Other criteria are used to determine the hierarchy of available network adapters. Such criteria include, but are not limited to, network bandwidth and/or adapter type. The network adapter hierarchy and preferences are stored in the policy manager, 105. The policy manager will apply the hierarchy of preferred network adapters to control the activation of any individual network adapter to conserve power. The sense driver 65 monitors all of the network adapters in the user device to determine the state thereof, 107. The states include, but are not limited to, powered, non-powered, and reduced power mode. The powered state includes sub-states, specifically, in communication with a base-station, and available for communication with a base-station. The sense driver 65 passes the sensed states of the network adapters to the policy manager 67. The policy manager, based on the data including sensed states received from the sense driver, applies the stored hierarchy and preference settings to the available network adapters. Specifically, the policy manager 67 can activate at least one preferred network adapter, 109. For example, the policy manager provides an activate signal to the network adapter manager 63₁. The policy manager 67 further deactivates all non-preferred network adapters, 111. This conserves battery power. The activated network adapter attempts to connect to a wireless base-station, 113. The process flow now determines if the connection is successful, 115. If the connection is successful, then the sense driver monitors the connection between the network adapter and the base-station, 117. If the connection is unsuccessful, then the policy manager is notified, 119. The policy manager then deactivates the prior preferred network adapter and selects the next preferred adapter in the hierarchy, 121. The process returns to step 113 and attempts to establish a network connection between the network adapter and the base-station.

While the above described embodiment of the invention refers to a single wireless network adapter being selected or activated, it will be understood that a plurality of the most preferred network adapters can operate at the same time, i.e., simultaneous multi-homed. Specifically, the policy manager 67 and activate at least two NICs 43 and 45 simultaneously to connect to a same network or two separate networks. The number and type of network adapters to activate at once can be programmed and stored in the policy manager.

The above describes embodiments of the present invention with regard to wireless systems. One embodiment of wireless systems includes WLAN technology. Other embodiments of the present invention can for use with other wireless technologies as described herein. Moreover, one of skill in the art will recognize how the present invention is adapted to other wireless technologies not mentioned herein to provide power conservation.

Further provided by various embodiments are methods and apparatus to reduce power dissipation within an electronic system, which includes multiple functional units that are used by a processor to execute software instructions. Embodiments of the invention can be used in portable and non-portable systems. Within portable systems (e.g., mobile telephones, laptop computers, personal data assistants, pagers, etc.), embodiments of the invention can be used to extend battery life by reducing power consumption and dissipation.

Although specific embodiments have been described and illustrated herein, it will be appreciated by those skilled in the art, having the benefit of the present disclosure, that any arrangement which is intended to achieve the same purpose may be substituted for a specific embodiment shown. This application is intended to cover any adaptations or variations of the present invention. Therefore, it is intended that this invention be limited only by the claims and the equivalents thereof.

1. A device, comprising:
a plurality of wireless network adapters;
a sense driver adapted to sense an operational state of at least two of the plurality of wireless network adapters; and
a policy manager adapted to receive state information from the sense driver and to selectively activate at least one of the plurality of wireless network adapters based on the state information.

2. The device of claim 1, wherein the policy manager is adapted to selectively hold at least one of a non-selected group of the plurality of wireless network adapters in a reduced power state, and wherein the non-selected group does not include an activated one of the plurality of wireless network adapters.

3. The device of claim 1, wherein the policy manager is adapted to store a hierarchy of preferred wireless network adapters.

4. The device of claim 3, wherein the policy manager is further adapted to selectively activate at least one of the plurality of wireless network adapters based on the hierarchy of preferred wireless network adapters.

5. The device of claim 4, wherein the policy manager is adapted to be programmed by a user to establish the hierarchy of preferred wireless network adapters.

6. The device of claim 1, wherein the plurality of wireless network adapters include at least one wireless network interface card adapted to operate according to an IEEE 802.11x standard.

7. The device of claim 1, wherein the plurality of wireless network adapters include at least one wireless network interface card adapted to operate according to a general packet radio service standard.

8. The device of claim 1, wherein the sense driver is adapted to continuously sense the operational state of each of the plurality of wireless network adapters.

9. A device, comprising:
a plurality of network adapters;
a sensing driver adapted to sense an operational state of at least two of the plurality of network adapters;
a policy manager adapted to receive state information from the sensing driver and to selectively activate at least one of the plurality of network adapters based on the state information and a hierarchy of preferred network adapters, the policy manager being adapted to selectively hold others of the plurality of network adapters based on the state information and a hierarchy of preferred network adapters in a reduced power state; and
a battery adapted to provide power to at least the plurality of network adapters.

10. The device of claim 9, wherein the policy manager is adapted to conserve power in the battery by deactivation of the non-selected ones of the plurality of network adapters.

11. The device of claim 10, wherein the battery is adapted to provide power to a host and a user input/output interface.

12. The device of claim 11, wherein the battery provides power to run the sensing driver and the policy manager.

13. The device of claim 12, wherein the plurality of network adapters includes at least one wireless network adapter.

14. The device of claim 9, wherein the selected one of the plurality of network adapters is continuously powered by the battery to maintain a connection with a base-station.

15. A method, comprising:
storing a hierarchy of network adapters;
sensing available network adapters;
activating a preferred available, network adapter according to the stored hierarchy; and
deactivating at least one of the other available network adapters.

16. The method of claim 15, wherein storing the hierarchy includes programming a network connection priority and a number of preferred available network adapters.

17. The method of claim 15, wherein storing a hierarchy of network adapters includes storing at least one wireless network adapter in the hierarchy, wherein activating the preferred network adapter includes attempting to connect the wireless network adapter to a wireless base-station of a wired network.

18. The method of claim 17, wherein sensing available wireless network adapters includes continuously sensing for newly available wireless network adapters.

19. The method of claim 18, wherein activating a preferred available, network adapter includes deactivating a less preferred network adapter if a more preferred network adapter is sensed to be available.

20. The method of claim 17, wherein sensing available network adapters includes continuously sensing whether the connection between the network adapter and the base-station is dropped.

21. The method of claim 20, wherein activating a preferred available, network adapter includes deactivating the preferred network adapter if the connection is dropped and activating a less preferred network adapter.

22. The method of claim 15, wherein activating a preferred available, network adapter includes deactivating the preferred network adapter if the preferred network adapter is sensed to be unavailable and activating a next, less preferred network adapter.

23. A system, comprising:
a wireless base-station;
a user device to connect to the wireless base-station, the user device including:
a plurality of wireless network adapters;
a sense driver adapted to sense an operational state of at least two of the plurality of wireless network adapters; and
a policy manager adapted to receive state information from the sense driver and to selectively activate at least one of the plurality of wireless network adapters based on the state information.

24. The system of claim 23, wherein the wireless base-station is adapted to communicate in at least one of a group of wireless technologies consisting essentially of General Packet Radio Service, IEEE 802.11x, IEEE 802.2, and IEEE 802.3.

25. The system of claim 24, wherein the plurality of wireless network adapters includes a first wireless network adapter to communicate by General Packet Radio Service, and a second wireless network adapter adapted to communicate by IEEE 802.11x .

26. The system of claim 23, wherein the policy manager is adapted to be programmed with a network connection priority and a number of preferred available wireless network adapters.

27. The system of claim 23, wherein the policy manager is adapted to activate a preferred one of the wireless network adapters that attempts to connect to the base-station.

28. The system of claim 23, wherein the sense driver is adapted to continuously sense for newly available wireless network adapters.

29. The system of claim 28, wherein the policy manager is adapted to deactivate a less preferred wireless network adapter if a more preferred wireless network adapter is sensed to be available.

30. The system of claim 23, wherein the sense driver is adapted to continuously sense whether the connection between the wireless network adapter and the base-station is dropped.

31. The system of claim 30, wherein the policy manager is adapted to deactivate the preferred wireless network adapter if the connection is dropped and to activate a less preferred wireless network adapter.
